(19) United States
(12) Patent Application Publication
(10) Pub. No.: US 2026/0286129 A1
(43) Pub. Date: Sep. 24, 2026

(54) THERMOPLASTIC COMPOSITION, ARTICLES PREPARED THEREFROM, AND METHOD FOR THE MANUFACTURE THEREOF

(71) Applicant: SHPP GLOBAL TECHNOLOGIES B.V., Bergen op Zoom (NL)

(72) Inventor: Kayoko Onda, Tochigi (JP)

(21) Appl. No.: 19/489,321

(22) PCT Filed: Jun. 7, 2024
(86) PCT No.: PCT/IB2024/055595

§ 371 Date: Dec. 2, 2025

(30) Foreign Application Priority Data
Jun. 9, 2023 (EP) 23178419.0

(51) Int. Cl. C08L 71/12; C08J 3/00; C08K 3/04; C08K 3/08; C08K 5/06; C08K 5/092

(52) U.S. Cl. CPC C08L 71/126; C08J 3/005; C08K 3/041; C08K 3/08; C08K 5/06; C08K 5/092; C08J 2371/12; C08J 2477/10; C08K 2003/0825; C08K 2003/085; C08K 2201/001; C08K 2201/003; C08K 2201/006; C08K 2201/011; C08L 2666/20

(57) ABSTRACT

A thermoplastic composition includes particular amounts of a poly(phenylene ether); a polyamide; an impact modifier; a conductive agent; a hydroxy-containing compound comprising bisphenoxyethanol fluorene, a terpene phenolic resin, a novolak resin, or a combination thereof; and a compatibilizing agent; wherein weight percent is based on the total weight of the thermoplastic composition.

### CROSS REFERENCE TO RELATED APPLICATION

This application claims priority to European Patent Application No. 23178419.0, filed on Jun. 9, 2023, the contents of which is hereby incorporated in its entirety herein.

### BACKGROUND

Poly(phenylene ether) s blended with polyamides can provide compositions having a wide variety of properties such as heat resistance, chemical resistance, impact strength, hydrolytic stability, and dimensional stability. For some applications it can be desirable to use poly(phenylene ether)/polyamide compositions with good conductivity, good melt flow, low water uptake, and good mechanical properties. Unfortunately, it can be difficult to achieve such a desirable balance of properties. For example, polyamides are well-known thermoplastic polymers having properties such as high melt flow, and excellent processability and chemical resistance. However, polyamide tends to absorb water over time, which can lead to warpage as well as low retention of mechanical strength. Poly(phenylene ether)/polyamide blends can exhibit low moisture uptake, however the melt flow is generally not sufficient for some applications. Other poly(phenylene ether)/polyamide blends can exhibit high melt flow, however the water uptake can be higher than the lower melt flow counterparts.

There accordingly remains a need in the art for poly(phenylene ether)/polyamide compositions exhibiting a combination of high melt flow and low water uptake. Improved conductivity of the poly(phenylene ether)/polyamide composition would be a further advantage.

### SUMMARY

A thermoplastic composition comprises 30 to 60 weight percent of a poly(phenylene ether); 30 to 60 weight percent of a polyamide; 1 to 20 weight percent of an impact modifier; 0.1 to 10 weight percent of a conductive agent; 1 to 10 weight percent of a hydroxy-containing compound comprising bisphenoxyethanol fluorene, a terpene phenolic resin, a novolak resin, or a combination thereof; and 0.01 to 10 weight percent of a compatibilizing agent; wherein weight percent is based on the total weight of the thermoplastic composition.

Another aspect of the present disclosure is an article composition the thermoplastic composition.

A method for the manufacture of the thermoplastic composition comprises melt-blending the components of the composition.

The above described and other features are exemplified by the following detailed description.

### DETAILED DESCRIPTION

The present inventors have advantageously discovered a composition which can be particularly well suited as a matrix resin for use in reinforced thermoplastics, for example for automotive applications. The compositions described herein can exhibit the desirable combination of high melt flow, low moisture absorption, high heat resistance, and good impact performance.

Accordingly, an aspect of the present disclosure is a thermoplastic composition. The composition includes particular amounts of a poly(phenylene ether), a polyamide, an impact modifier, a conductive agent, a hydroxy-containing compound, and a compatibilizing agent.

The composition comprises a poly(phenylene ether) (also referred to herein as “PPE”). The poly(phenylene ether) comprises phenylene ether units having the structure

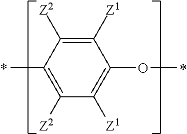

wherein each occurrence of Z¹ is independently halogen, unsubstituted or substituted C₁₋₁₂ hydrocarbyl, provided that the hydrocarbyl group is not tertiary hydrocarbyl, C₁₋₁₂ hydrocarbylthio, C₁₋₁₂ hydrocarbyloxy, or C₂₋₁₂ halohydrocarbyloxy wherein at least two carbon atoms separate the halogen and oxygen atoms; and each occurrence of Z² is independently hydrogen, halogen, unsubstituted or substituted C₁₋₁₂ hydrocarbyl provided that the hydrocarbyl group is not tertiary hydrocarbyl, C₁₋₁₂ hydrocarbylthio, C₁₋₁₂ hydrocarbyloxy, or C₂₋₁₂ halohydrocarbyloxy wherein at least two carbon atoms separate the halogen and oxygen atoms. The poly(phenylene ether) can have aminoalkyl-containing end group(s), typically located in a position ortho to the hydroxy group. As one example, Z¹ can be a di-n-butylaminomethyl group formed by reaction of a terminal 3,5-dimethyl-1,4-phenyl group with the di-n-butylamine component of an oxidative polymerization catalyst. Also frequently present are tetramethyldiphenoquinone (TMDQ) end groups, typically obtained from 2,6-dimethylphenol-containing reaction mixtures in which tetramethyldiphenoquinone by-product is present. The poly(phenylene ether) can be in the form of a homopolymer, a random copolymer, a graft copolymer, or a block copolymer, as well as a combination thereof. In an aspect, the poly(phenylene ether) is a homopolymer, preferably poly(2,6-dimethyl-1,4-phenylene ether).

In an aspect, the poly(phenylene ether) has an intrinsic viscosity of 0.2 to 1 deciliter per gram measured by Ubbelohde viscometer at 25° C. in chloroform. Within this range, the poly(phenylene ether) intrinsic viscosity can be 0.2 to 0.6 deciliter per gram, or 0.25 to 0.5 deciliter per gram, or 0.3 to 0.5 deciliter per gram, or 0.33 to 0.46 deciliter per gram.

In a specific aspect, the poly(phenylene ether) is a poly(2,6-dimethyl-1,4-phenylene ether) having an intrinsic viscosity of 0.2 to 0.6 deciliter per gram, measured by Ubbelohde viscometer at 25° C. in chloroform. Within the range of 0.2 to 0.6 deciliter per gram, the poly(2,6-dimethyl-1,4-phenylene ether) intrinsic viscosity can be 0.3 to 0.5 deciliter per gram, more preferably 0.33 to 0.46 deciliter per gram.

Poly(phenylene ethers) which optionally may be in the form of a copolymer of two or more monomers, for example a terpolymer, and the raw materials used to produce the poly(phenylene ethers) may be, or may be formed from, renewable, sustainable, bio-circular, circular, lower carbon footprint feedstocks, upcycled, and/or post-consumer/post-industrial recycled materials, including pyrolysis oil (“py-oil”).

Poly(phenylene ethers) made from renewable sources may include, for example, a bio-content or PCR content of up to about 99.9%, about 1-99%, 5-95%, 55-99%, or 80-99%, 1-50%, 1-25%, 1-15%, 1-10%, or 1-5%, based, e.g., on the monomer source. The poly(phenylene ether) can be, e.g., an oligomer with as few as two repeating units to ultra-high molecular weight poly(phenylene ethers). The weight average molecular weight of the poly(phenylene ethers) in one non-limiting embodiment may range from 600 to 200,000 grams per mole, as determined by gel permeation chromatography. In another non-limiting aspect, the poly(phenylene ethers) may have an intrinsic viscosity of up to 1.5 deciliters per gram (dl/g) as measured at 25° C. in chloroform. Poly(phenylene ethers) made from renewable sources may include material made by a mass balance approach and certified by regulatory bodies such as, for example, the ISCC Plus.

Poly(phenylene ethers) in an aspect may be prepared by oxidative polymerization of monomers in the presence of a polymerization catalyst in the presence of oxygen. Any of the components used in the polymerization reaction or their synthetic precursors, or the solvents used in the process, may be bio-sourced, bio-circular, or renewable raw materials. Such components and precursors include monomers (e.g., monohydric phenol, dihydric phenol and other comonomers), reagents, solvents, catalysts (e.g., a metal source, a secondary alkylene diamine ligand, a tertiary monoamine, and optionally a secondary monoamine or alternatively enzyme catalysts), gases (e.g., oxygen gas), or any combinations thereof. In some aspects, reaction components used in the polymerization of poly(phenylene ethers) may be from sources as listed in the EU Renewable Energy Directive Annex IX.

Poly(phenylene ethers) can be further processed, such as by redistribution, or any chemical derivatization, such as post-polymerization end-group capping or coupling, to make other materials that can transfer the sustainability characteristic to the new material. Such reagents and/or their synthetic precursors may be sustainable, bio-sourced, bio-circular, or renewable raw materials, upcycled, and/or post-consumer/post-industrial recycled materials, including pyrolysis oil (“py-oil”), to produce a poly(phenylene ether).

Biosourced and sustainable materials may be derived from biomass sources or industrial sources such as waste (e.g., municipal waste). Biomass is a renewable organic material that comes from organic matter. Lignocellulosic biomass, the most abundant type of biomass and includes a wide variety of different biomass types including grasses, wood, energy crops, and agricultural and municipal wastes, is mostly composed of cellulose, hemicellulose, and lignin. Depolymerization of lignin, which is a phenolic polymer, can provide phenol. Solvents used in the production of monomers, such as methanol and acetone can be obtained from syngas, which is a product of the gasification of biomass.

Poly(phenylene ether), such as a recycled poly(phenylene ether) comprising an open- or closed-loop post-consumer recycled (“PCR”) poly(phenylene ether), an open- or closed-loop post-industrial recycled (“PIR”) poly(phenylene ether), or upcycled polyphenylene ether or a combination thereof may be used, provided that the desired property or combination of properties may be achieved. As used herein, the term “post-consumer recycle poly(phenylene ether)” refers to a poly(phenylene ether) that has reached the intended user or consumer and which has been collected or reclaimed after utilization by the end-user or consumer. Thus, for example, it is understood that that the term refers to a poly(phenylene ether) material in whole or in part that would have otherwise been disposed of as waste, but has instead been collected and recovered (reclaimed) as a material input, in lieu of a virgin material, for a recycling or manufacturing process. PCR-poly(phenylene ether) is inclusive of material that has been reprocessed from collected or reclaimed material by means of a manufacturing process, (including e.g., purification, sorting, and pretreating) and made into a product or into a component for incorporation into a product. Such recycled poly(phenylene ether) s can be further processed, for example, into the form of powders, ground materials, flakes, pellets or other form. As used herein, the term “post-industrial recycled poly(phenylene ether)” refers to a poly(phenylene ether) polymer or polymers that have never reached the end user and that is production waste arising during polymerization reactions, during further processing, or during manufacturing the resin or an article and includes materials such as, but not limited to, sprues from injection molding, start-up material from injection molding or extrusion, extrusion scrap, molding scrap, edge trims from extruded sheets or films, and the like, including materials diverted from the waste stream during a manufacturing process for an article.

The composition includes the poly(phenylene ether) in an amount of 30 to 60 weight percent, based on the total weight of the composition. Within this range, the poly(phenylene ether) amount can be 30 to 55 weight percent or 30 to 50 weight percent, or 32 to 50 weight percent, or 35 to 50 weight percent, or 35 to 49 weight percent, or 35 to 48 weight percent, or 35 to 46 weight percent, each based on the total weight of the composition.

In addition to the poly(phenylene ether), the composition comprises a polyamide. Polyamides, also known as nylons, are polymers containing amide (i.e., —C(═O)NH—) linking groups, for example as described in U.S. Pat. No. 4,970,272 to Gallucci. Polyamides that can be used include a polyamide-6, a polyamide-6,6, a polyamide-6,10, a polyamide-4,10, a polyamide-5,10, polyamide 10,10, polyamide 9T, polyamide 6T, polyamide 10T, polyamide 6I, polyamide MXD6, or a combination thereof. In an aspect, the polyamide comprises polyamide-6, polyamide-6,6, or a combination thereof, preferably polyamide-6,6. In an aspect, the polyamide comprises polyamide-6,10. Polyamides such as polyamide-6 and polyamide-6,6 are commercially available from a number of sources and methods for their preparation are known. For example, polyamides can be obtained by a number of well-known processes such as those described in U.S. Pat. Nos. 2,071,250, 2,071,251, 2,130,523, and 2,130,948 to Carothers; U.S. Pat. Nos. 2,241,322 and 2,312,966 to Hanford; and U.S. Pat. No. 2,512,606 to Bolton et al.

The polyamide can be a virgin material or a recycled or upcycled material. In an aspect, the polyamide can be a virgin material, wherein polyamides that have been used in end-use parts are excluded. In an aspect, the polyamide can be, at least partially, a polyamide that has been recovered from end-use parts. For example, the polyamide can be a post-consumer recycled polyamide, a post-industrial recycled polyamide, a chemical recycled polyamide or a combination thereof. In an aspect, the polyamide can be a combination of a virgin polyamide and a recycled polyamide.

In an aspect, the polyamide can be a biopolyamide. A “biopolyamide” is defined as a polyamide derived totally or in part from a renewable source, such as from a plant or animal, as determined by biobased carbon content of the biopolyamide as measured by ASTM D6866 (Standard Test Methods for Determining the Biobased Content of Natural Range Materials Using Radiocarbon and Isotope Ratio Mass Spectrometry Analysis). ASTM D6866 provides three methods for measuring organic carbon originating from renewable raw materials, referred to as biobased carbon. The proportions indicated for the polyamides of the invention are preferably measured by the mass spectrometry method or by the liquid scintillation spectrometry method described in this standard.

In consequence, the presence of ¹⁴C in a material, regardless of the quantity involved, provides information about the origin of the molecules making it up; that is the presence of ¹⁴C in a material indicates that a certain fraction originates from renewable raw materials and no longer from fossil materials. The measurements taken by the methods described in standard ASTM D6866 thereby serve to distinguish the monomers or starting reactants issuing from renewable materials from the monomers or reactants issuing from fossil materials. The term “bio-based” means a compound, composition and/or other organic material that is “isotopically rich” in carbon 14 as compared to a petroleum source, as determined by ASTM D6866. The term “bio-mass” means living and recently dead biological material which excludes organic material that has been transformed by geological processes into a member selected from the group consisting of petroleum, petrochemicals, and combinations thereof. The term “isotopically rich” means a higher carbon 14 to carbon 12 ratio in a compound, composition and/or other organic material as compared to the carbon 14 to carbon 12 ratio from a petroleum source.

The following biopolyamides have varying levels of biobased carbon content as measured by ASTM D6866 and are commercially available. Polyamide 10T is poly(decamethylene terephthalamide) is based to the extent of about 50% on decanediamine, a renewable raw material derived from castor beans. Polyamide 410 (PA410) is made by polycondensation of tetramethylene diamine and sebacic acid, which is available from castor oil. PA 410 contains 70 percent biobased carbon and is available from DSM under the tradename EcoPaXX™. Polyamide 610 (PA610) is made by polycondensation of hexamethylene diamine and sebacic acid, which is available from castor oil. PA 610 contains at least 63 percent biobased carbon and is available from the following suppliers: BASF, under the tradename Ultramid Balance; Evonik, under the tradename Vestamid TerraHS; Dupont, under the tradename Zytel RS LC; EMS-Grivory, under the tradename Grilamid 2S; Rhodia, under the tradename Technyl eXten; and Akro Plastik, under the tradename Akromid S. Polyamide 1010 (PA1010) is made by polycondensation of decamethylene diamine and sebacic acid, which is available from castor oil and contains up to 100 percent biobased carbon depending on the source of decamethylene diamine. PA 1010 is available from the following suppliers: EMS-Grivory, under the tradename Grilamid 1S; Evonik, under the tradename Vestamid Terra DS; and Dupont, under the tradename Zytel RS LC. Polyamide 1012 (PA1012) is made by polycondensation of decamethylene diamine and dodecanoic acid. Both components are derivable from vegetable oil and thus PA1012 may contain 45 percent, or more, biobased carbon. PA1012 is available from Evonik under the tradename Vastamid TerraDD.

The polyamide can be present in an amount of 30 to 60 weight percent, based on the total weight of the composition. Within this range, the polyamide can be present in an amount of 30 to 55 weight percent, or 30 to 50 weight percent, or 32 to 50 weight percent, or 34 to 55 weight percent, or 34 to 50 weight percent.

In addition to the poly(phenylene ether) and the polyamide, the composition comprises an impact modifier. Suitable impact modifiers are typically high molecular weight elastomeric materials derived from olefins, monovinyl aromatic monomers, acrylic and methacrylic acids and their ester derivatives, as well as conjugated dienes. The polymers formed from conjugated dienes can be fully or partially hydrogenated. The elastomeric materials can be in the form of homopolymers or copolymers, including random, block, radial block, graft, and core-shell copolymers. Combinations of impact modifiers can be used.

In an aspect, the impact modifier can comprise an elastomer-modified graft copolymer comprising (i) an elastomeric (i.e., rubbery) polymer substrate having a Tg less than 10° C., more preferably less than −10° C., or more preferably −40° to −80° C., and (ii) a rigid polymeric superstrate grafted to the elastomeric polymer substrate. Materials suitable for use as the elastomeric phase include, for example, conjugated diene rubbers, for example polybutadiene and polyisoprene; copolymers of a conjugated diene with less than 50 wt. % of a copolymerizable monomer, for example a monovinylic compound such as styrene, acrylonitrile, n-butyl acrylate, or ethyl acrylate; olefin rubbers such as ethylene propylene copolymers (EPR) or ethylene-propylene-diene monomer rubbers (EPDM); ethylene-vinyl acetate rubbers; silicone rubbers; elastomeric C₁₋₈ alkyl (meth)acrylates; elastomeric copolymers of C₁₋₈ alkyl (meth)acrylates with butadiene or styrene; or combinations thereof. Materials suitable for use as the rigid phase include, for example, monovinyl aromatic monomers such as styrene and alpha-methyl styrene, and monovinylic monomers such as acrylonitrile, acrylic acid, methacrylic acid, and the C₁₋₆ esters of acrylic acid and methacrylic acid, preferably methyl methacrylate.

Specific elastomer-modified graft copolymers include those formed from styrene-butadiene-styrene (SBS), styrene-butadiene rubber (SBR), styrene-ethylene-butadiene-styrene (SEBS), ABS (acrylonitrile-butadiene-styrene), acrylonitrile-ethylene-propylene-diene-styrene (AES), styrene-isoprene-styrene (SIS), methyl methacrylate-butadiene-styrene (MBS), styrene-acrylonitrile (SAN), and maleic anhydride grafted ethylene-propylene rubber (commercially available as Exxelor™ VA 1801 from Exxon Chemicals Ltd).

In a specific aspect, the impact modifier comprises a hydrogenated block copolymer of an alkenyl aromatic monomer and a conjugated diene. For brevity, this component is referred to as the “hydrogenated block copolymer”. The hydrogenated block copolymer can comprise 10 to 90 weight percent of poly(alkenyl aromatic) content and 90 to 10 weight percent of hydrogenated poly(conjugated diene) content, based on the weight of the hydrogenated block copolymer. In an aspect, the hydrogenated block copolymer is a low poly(alkenyl aromatic content) hydrogenated block copolymer in which the poly(alkenyl aromatic) content is 10 to less than 40 weight percent, specifically 20 to 35 weight percent, more specifically 25 to 35 weight percent, yet more specifically 25 to 30 weight percent, all based on the weight of the low poly(alkenyl aromatic) content hydrogenated block copolymer. In other aspects, the hydrogenated block copolymer is a high poly(alkenyl aromatic content) hydrogenated block copolymer in which the poly(alkenyl aromatic) content is 40 to 90 weight percent, specifically 50 to 80 weight percent, more specifically 60 to 70 weight percent, all based on the weight of the high poly(alkenyl aromatic content) hydrogenated block copolymer. In a specific aspect, the hydrogenated block copolymer can have a poly(alkenyl aromatic) content of 28 to 37 weight percent.

In an aspect, the hydrogenated block copolymer has a weight average molecular weight of 40,000 to 400,000 grams per mole (g/mole or daltons, Da). The number average molecular weight and the weight average molecular weight can be determined by gel permeation chromatography and based on comparison to polystyrene standards. In an aspect, the hydrogenated block copolymer has a weight average molecular weight of 200,000 to 400,000 grams per mole, specifically 220,000 to 350,000 grams per mole. In other aspects, the hydrogenated block copolymer has a weight average molecular weight of 40,000 to 200,000 grams per mole, specifically 40,000 to 180,000 grams per mole, more specifically 40,000 to 150,000 grams per mole.

The alkenyl aromatic monomer used to prepare the hydrogenated block copolymer can have the structure

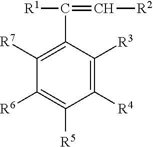

wherein R¹ and R² each independently represent a hydrogen atom, a C₁₋₈ alkyl group, or a C₂₋₈ alkenyl group; R³ and R⁷ each independently represent a hydrogen atom, a C₁₋₈ alkyl group, a chlorine atom, or a bromine atom; and R⁴, R⁵, and R⁶ each independently represent a hydrogen atom, a C₁₋₈ alkyl group, or a C₂₋₈ alkenyl group, or R⁴ and R⁵ are taken together with the central aromatic ring to form a naphthyl group, or R⁵ and R⁶ are taken together with the central aromatic ring to form a naphthyl group. Specific alkenyl aromatic monomers include, for example, styrene, chlorostyrenes such as p-chlorostyrene, methylstyrenes such as alpha-methylstyrene and p-methylstyrene, and t-butylstyrenes such as 3-t-butylstyrene and 4-t-butylstyrene. In an aspect, the alkenyl aromatic monomer is styrene.

The conjugated diene used to prepare the hydrogenated block copolymer can be a C₄₋₂₀ conjugated diene. Suitable conjugated dienes include, for example, 1,3-butadiene, 2-methyl-1,3-butadiene, 2-chloro-1,3-butadiene, 2,3-dimethyl-1,3-butadiene, 1,3-pentadiene, 1,3-hexadiene, and the like, and combinations thereof. In an aspect, the conjugated diene is 1,3-butadiene, 2-methyl-1,3-butadiene, or a combination thereof. In an aspect, the conjugated diene is 1,3-butadiene.

The hydrogenated block copolymer is a copolymer comprising (A) at least one block derived from an alkenyl aromatic compound and (B) at least one block derived from a conjugated diene, in which the aliphatic unsaturated group content in the block (B) is at least partially reduced by hydrogenation. In an aspect, the aliphatic unsaturation in the (B) block is reduced by at least 50 percent, specifically at least 70 percent. The arrangement of blocks (A) and (B) includes a linear structure, a grafted structure, and a radial teleblock structure with or without a branched chain. Linear block copolymers include tapered linear structures and non-tapered linear structures. In an aspect, the hydrogenated block copolymer has a tapered linear structure. In an aspect, the hydrogenated block copolymer has a non-tapered linear structure. In an aspect, the hydrogenated block copolymer comprises a (B) block that comprises random incorporation of alkenyl aromatic monomer. Linear block copolymer structures include diblock (A-B block), triblock (A-B-A block or B-A-B block), tetrablock (A-B-A-B block), and pentablock (A-B-A-B-A block or B-A-B-A-B block) structures as well as linear structures containing 6 or more blocks in total of (A) and (B), wherein the molecular weight of each (A) block can be the same as or different from that of other (A) blocks, and the molecular weight of each (B) block can be the same as or different from that of other (B) blocks. In an aspect, the hydrogenated block copolymer is a diblock copolymer, a triblock copolymer, or a combination thereof.

In an aspect, the hydrogenated block copolymer excludes the residue of monomers other than the alkenyl aromatic compound and the conjugated diene. In an aspect, the hydrogenated block copolymer consists of blocks derived from the alkenyl aromatic compound and the conjugated diene. It does not comprise grafts formed from these or any other monomers. It also consists of carbon and hydrogen atoms and therefore excludes heteroatoms. In an aspect, the hydrogenated block copolymer includes the residue of one or more acid functionalizing agents, such as maleic anhydride. In an aspect, the hydrogenated block copolymer comprises a polystyrene-poly(ethylene-butylene)-polystyrene triblock copolymer.

In an aspect, the hydrogenated block copolymer is a polystyrene-poly(ethylene-propylene) diblock copolymer, a polystyrene-poly(ethylene-butylene)-polystyrene triblock copolymer, or a combination thereof. In an aspect, the hydrogenated block copolymer is a polystyrene-poly(ethylene-propylene) diblock copolymer, a polystyrene-poly(ethylene-butylene)-polystyrene triblock copolymer, or a combination thereof having a polystyrene content of 28 to 37 weight percent. In an aspect, the hydrogenated block copolymer comprises the polystyrene-poly(ethylene-propylene) diblock copolymer and the polystyrene-poly(ethylene-butylene)-polystyrene triblock copolymer.

Methods for preparing hydrogenated block copolymers are known in the art and many hydrogenated block copolymers are commercially available. Illustrative commercially available hydrogenated block copolymers include the polystyrene-poly(ethylene-propylene) diblock copolymers available from Kraton Performance Polymers Inc. as KRATON™ G1701 (having about 37 weight percent polystyrene) and G1702 (having about 28 weight percent polystyrene); the polystyrene-poly(ethylene-butylene)-polystyrene triblock copolymers available from Kraton Performance Polymers Inc.as KRATON™ G1641 (having about 33 weight percent polystyrene), G1650 (having about 30 weight percent polystyrene), G1651 (having about 33 weight percent polystyrene), and G1654 (having about 31 weight percent polystyrene); and the polystyrene-poly(ethylene-ethylene/propylene)-polystyrene triblock copolymers available from Kuraray as SEPTON™ S4044, S4055, S4077, and S4099. Additional commercially available hydrogenated block copolymers include polystyrene-poly(ethylene-butylene)-polystyrene (SEBS) triblock copolymers available from Dynasol as CALPRENE™ H6140 (having about 31 weight percent polystyrene), H6170 (having about 33 weight percent polystyrene), H6171 (having about 33 weight percent polystyrene), and H6174 (having about 33 weight percent polystyrene); and from Kuraray as SEPTON™ 8006 (having about 33 weight percent polystyrene) and 8007 (having about 30 weight percent polystyrene); polystyrene-poly(ethylene-propylene)-polystyrene (SEPS) copolymers available from Kuraray as SEPTON™ 2006 (having about 35 weight percent polystyrene) and 2007 (having about 30 weight percent polystyrene); and oil-extended compounds of these hydrogenated block copolymers available from Kraton Performance Polymers Inc.as KRATON™ G4609 (containing about 45% mineral oil, and the SEBS having about 33 weight percent polystyrene) and G4610 (containing about 31% mineral oil, and the SEBS having about 33 weight percent polystyrene); and from Asahi as TUFTEC™ H1272 (containing about 36% oil, and the SEBS having about 35 weight percent polystyrene). Mixtures of two of more hydrogenated block copolymers can be used.

In an aspect, the hydrogenated block copolymer has a weight average molecular weight of 40,000 to 400,000 grams per mole (g/mol). The number average molecular weight and the weight average molecular weight can be determined by gel permeation chromatography and based on comparison to polystyrene standards. In an aspect, the hydrogenated block copolymer has a weight average molecular weight of 200,000 to 400,000 g/mol, or 220,000 to 350,000 g/mol. In an aspect, the hydrogenated block copolymer has a weight average molecular weight of 40,000 to 200,000 g/mol, or 40,000 to 180,000 g/mol, or 40,000 to 150,000 g/mol.

The impact modifier can be present in an amount of 1 to 20 weight percent, based on the total weight of the composition. Within this range, the amount of the impact modifier can be 3 to 20 weight percent, or 3 to 15 weight percent, or 5 to 20 weight percent, or 5 to 15 weight percent, or 5 to 13 weight percent, or 8 to 15 weight percent, or 8 to 12 weight percent, each based on the total weight of the composition.

In a specific aspect, the impact modifier can comprise the hydrogenated block copolymer, and can be present in an amount of 1 to 20 weight percent, based on the total weight of the composition. Within this range, the amount of the hydrogenated block copolymer can be 3 to 20 weight percent, or 3 to 15 weight percent, or 5 to 20 weight percent, or 5 to 15 weight percent, or 5 to 13 weight percent, or 8 to 15 weight percent, or 8 to 12 weight percent, each based on the total weight of the composition.

In addition to the poly(phenylene ether), the polyamide, and the impact modifier, the composition further comprises a conductive agent. The conductive agent can be any agent that enhances the conductivity of the composition. Suitable conductive fillers may be fibrous, disc-shaped, spherical or amorphous. Suitable conductive agents can include, for example, graphite, conductive carbon black, conductive carbon fibers, metal fibers, metal particles, particles of intrinsically conductive polymers, and the like. In an aspect, the conductive agent can comprise carbon black, carbon fiber, carbon nanotubes, or a combination thereof.

Other conductive fillers which can be used are metal-coated carbon fibers; metal fibers; metal disks; metal particles; metal-coated disc-shaped fillers such as metal-coated talcs, micas and kaolins; and the like. In an aspect, preferred conductive fillers include carbon black, carbon fibers, carbon nanotubes, and mixtures thereof.

In an aspect, the conductive filler can comprise carbon black. Carbon black may refer to an amorphous form of carbon with a high surface-area-to-volume ratio. Further, carbon black may include a chemisorbed oxygen complex (such as, carboxylic, quinonic, lactonic, phenolic groups and the like) on its surface to varying degrees, depending on the conditions of manufacture. Carbon black properties such as particle size, structure, and purity may vary depending on the type of carbon black chosen. In an aspect, carbon black can disperse well within the composition, maintain the integrity of its structure or network, and have a consistent particle size. The conductive carbon black of the present disclosure does not refer to carbon black for colorant purposes. As used herein, the term “conductive carbon black” refers to specific carbon blacks having particular surface area, oil absorption number (OAN), and other properties, as discussed further herein. Conductive carbon black has a high surface area and OAN (e.g., it is highly structured) relative to carbon blacks typically used as colorants.

In an aspect, the conductive carbon black useful in the present disclosure may be furnace black or acetylene black or an extra conductive carbon black. Conductive carbon black such as furnace black or acetylene black may have a high-volume resistivity, for example within a range of 1 to 10² Ω-cm. Useful conductive carbon blacks of the present disclosure may exhibit a BET (Brunauer, Emmett and Teller) specific surface area of at least 50 meters squared per gram (m²/g), for example 50 to 1000 m²/g.

In an aspect, the electrically conductive filler may comprise a highly structured carbon black. Highly structured carbon black may provide higher viscosity, greater electrical conductivity and easier dispersion. Measures of aggregate structure may be obtained from shape distributions from scanning electron microscopy (SEM) analysis and oil absorption number (OAN). OAN is a measure of the ability of a carbon black to absorb liquids. It's the number of cubic centimeters of dibutyl phthalate (DBP) or paraffin oil absorbed by 100 g of carbon black under specified conditions. The OAN value is proportional to the degree of aggregation of structure level of the carbon black. Test Methods such as ASTM D 2414 and D 3493 can be used to determine OAN. OAN values of less than 100 milliliters per 100 gram (ml/100 g) can be considered low structured carbons, and are typical of carbon black for black colorant, reinforcing additives, or UV absorption. OAN values from 100 to 140 ml/100 g can be considered medium level structured carbon black and are mainly used for wire and cable insulation shield and electrostatic discharge applications. OAN values of greater than 140 ml/100 g can be considered a highly structured carbon black, while OAN values greater than 280 ml/100 g may be extra or super high level structured carbon black.

In an aspect, the conductive carbon black useful in the present composition can exhibit an OAN of at least 100 ml/100 g, or at least 150 ml/100 g. In an aspect, the disclosed composition may comprise a highly structured conductive carbon black having an OAN value of at least 140 ml/100 g when tested in accordance with ASTM D 2414 and/or D 3493. In an aspect the conductive carbon black can have a DBP absorption amount of 80 to 500 ml/100 g.

An exemplary conductive carbon black is available from Earache Europe or Imerys Graphite & Carbon Switzerland as ENSACO™ 250 G carbon powder.

In an aspect, the composition may comprise an electrically conductive carbon black having at least one dimension of a particular size. The electrically conductive carbon black may comprise a powder having a particular particle size distribution. For example, the electrically conductive carbon black may have at least one dimension that is less than 100 nm. However, these particles may agglomerate together to have a certain structure and increased aggregate dimensions that may be at a micrometer scale in size. In an aspect, the electrically conductive carbon black may have a particular diameter. For example, the electrically conductive carbon black may have a primary particle diameter of 10 to 50 nm. In further examples, the conductive carbon black may have a primary particle size (or particle diameter) of 20 to 50 nm.

Exemplary conductive carbon blacks can include the conductive carbon blacks having average particle sizes less than 200 nanometers, preferably less than 100 nanometers, more preferably less than 50 nanometers. Preferred conductive carbon blacks may also have surface areas greater than 200 m²/g, preferably greater than 400 m²/g, yet more preferably greater than 1000 m²/g. Preferred conductive carbon blacks may also have a pore volume (dibutyl phthalate absorption) greater than 40 cm³/100 g, preferably greater than 100 cm³/100 g, more preferably greater than 150 cm³/100 g. Preferred conductive carbon blacks may also have a volatiles content less than about 2 weight percent. Especially preferred carbon fibers include the graphitic or partially graphitic vapor grown carbon fibers having diameters of 3.5 to 500 nanometers, with diameters of 3.5 to 70 nanometers being preferred, and diameters of 3.5 to 50 nanometers being more preferred. Representative carbon fibers are the vapor grown carbon fibers described in, for example, U.S. Pat. Nos. 4,565,684 and 5,024,818 to Tibbetts et al.; U.S. Pat. No. 4,572,813 to Arakawa; U.S. Pat. Nos. 4,663,230 and 5,165,909 to Tennent; U.S. Pat. No. 4,816,289 to Komatsu et al.; U.S. Pat. No. 4,876,078 to Arakawa et al.; U.S. Pat. No. 5,589,152 to Tennent et al.; and U.S. Pat. No. 5,591,382 to Nahass et al.

Exemplary conductive carbon fibers can include those having a length of 0.25 inch and a diameter of 7 micrometers. Conductive carbon fibers can also include agglomerates of fibers having an aspect ratio of at least 5 and an average diameter of 3.5 to 500 nanometers as described, for example, in U.S. Pat. Nos. 4,565,684 and 5,024,818 to Tibbetts et al.; U.S. Pat. No. 4,572,813 to Arakawa; U.S. Pat. Nos. 4,663,230 and 5,165,909 to Tennent; U.S. Pat. No. 4,816,289 to Komatsu et al.; U.S. Pat. No. 4,876,078 to Arakawa et al.; U.S. Pat. No. 5,589,152 to Tennent et al.; and U.S. Pat. No. 5,591,382 to Nahass et al. Exemplary graphite particles can have an average particle size of 20 to 1,000 nanometers and a surface area of 1 to 100 m²/g. Exemplary intrinsically conductive polymers can include polyanilines, polypyrroles, polyphenylene, polyacetylenes, and the like.

In a specific aspect, the conductive agent can comprise carbon nanotubes. The carbon nanotubes can be single wall or multiwall. In an aspect, the carbon nanotubes can be multiwall. In an aspect, the carbon nanotubes can have an average diameter of 2 to 20 nanometers.

The conductive agent can be present in the composition in an amount of 0.1 to 10 weight percent, based on the total weight of the composition. Within this range, the conductive agent can be present in an amount of 0.5 to 8 weight percent, or 0.5 to 5 weight percent, or 0.6 to 2.5 weight percent, or 0.7 to 1.8 weight percent, or 0.8 to 1.2 weight percent, each based on the total weight of the composition. In some aspects, when the conductive agent is conductive carbon black, the conductive carbon black can be present in an amount of less than 2 weight percent, or less than 1.5 weight percent, or less than 1.2 weight percent, or 0.1 to 1.8 weight percent, or 0.1 to 1.2 weight percent, or 0.7 to 1.8 weight percent, or 0.8 to 1.2 weight percent, each based on the total weight of the composition. In some aspects, when the conductive agent is conductive carbon black, the conductive carbon black can be present in an amount of greater than 2 weight percent, or 2.2 to 10 weight percent, or 2.5 to 10 weight percent, or 3 to 10 weight percent, each based on the total weight of the composition.

The thermoplastic composition further comprises a hydroxy-containing compound. The hydroxy containing compound comprises or is selected from bisphenoxyethanol fluorene, a terpene phenolic resin, a novolak resin, or a combination thereof. In an aspect, the hydroxy-containing compound comprises bisphenoxyethanol fluorene. In an aspect, the hydroxy-containing compound comprises the terpene phenolic resin (i.e., a resin prepared from terpene and phenolic compound). Terpene phenolic resin can refer to a terpene phenol copolymer resin and a phenol-modified terpene resin, with the former being a copolymer of a terpene and a phenolic compound, and the latter being a phenol-modification product of a terpene homopolymer or a terpene copolymer (a terpene resin, typically an unmodified terpene resin). Exemplary terpenes comprising the terpene phenolic resin can include mono-terpenes such as α-pinene, β-pinene, limonene (including d-limonene, 1-limonene, and d/l-limonene (dipentene)), and the like. In an aspect, the terpene phenolic resin has a hydroxyl value of 50 to 150 mg KOH/g. In an aspect, the hydroxy-containing compound comprises the novolak resin. Novolak resin as used herein refers to oligomers and polymers derived from phenols and formaldehyde. Phenol-formaldehyde resins can be prepared by reacting at least one aldehyde with at least one phenol or substituted phenol in the presence of an acid or other catalyst such that there is a molar excess of the phenol or substituted phenol. Suitable phenols and substituted phenols include phenol, o-cresol, m-cresol, p-cresol, thymol, ethylphenol, propylphenol, p-butylphenol, tert-butylcatechol, pentylphenol, hexylphenol, octaphenol, heptylphenol, nonylphenol, bisphenol-A, hydroxynaphthalene, resorcinol, bisphenol A, isoeugenol, o-methoxy phenol, 4,4′-dihydroxyphenyl-2,2-propane, isoamyl salicylate, benzyl salicylate, methyl salicylate, 2,6-di-tert-butyl-p-cresol, and the like. Suitable aldehydes and aldehyde precursors include formaldehyde, paraformaldehyde, polyoxymethylene, trioxane, and the like. More than one aldehyde or phenol may be used in the preparation of the novolak resin. In an aspect the novolak resin has a phenolic content of 0.1 to 3 weight percent, based on the total weight of the novolak resin.

The hydroxy-containing compound can be present in the thermoplastic composition in an amount of 1 to 10 weight percent, based on the total weight of the composition. Within this range, the hydroxy-containing compound can be present in an amount of 1 to 8 weight percent, or 1.2 to 7.8 weight percent, or 1.3 to 7.5 weight percent, or 1 to 7 weight percent, or 1.5 to 7 weight percent, or 1.5 to 6.5 weight percent, each based on the total weight of the composition.

The composition further comprises a compatibilizing agent. As used herein, the term “compatibilizing agent” refers to a polyfunctional compound that interacts with the poly(phenylene ether), the polyamide, or both. This interaction can be chemical (for example, grafting) and/or physical (for example, affecting the surface characteristics of the dispersed phases). In either instance the resulting composition exhibits improved compatibility, particularly as evidenced, for example, by enhanced impact strength, mold knit line strength, or tensile elongation.

Examples of compatibilizing agents that can be employed include liquid diene polymers, epoxy compounds, oxidized polyolefin wax, quinones, organosilane compounds, polyfunctional compounds, functionalized poly(arylene ether) s, and combinations thereof. Compatibilizing agents are further described in U.S. Pat. No. 5,132,365 to Gallucci, and 6,593,411 and 7,226,963 to Koevoets et al.

In an aspect, the compatibilizing agent comprises a polyfunctional compound. Polyfunctional compounds that can be employed as a compatibilizing agent are typically of three types. The first type of polyfunctional compound has in the molecule both (a) a carbon-carbon double bond or a carbon-carbon triple bond and (b) at least one carboxylic acid, anhydride, amide, ester, imide, amino, epoxy, orthoester, or hydroxy group. Examples of such polyfunctional compounds include maleic acid; maleic anhydride; fumaric acid; glycidyl acrylate, itaconic acid; aconitic acid; maleimide; maleic hydrazide; reaction products resulting from a diamine and maleic anhydride, maleic acid, fumaric acid, etc.; dichloro maleic anhydride; maleic acid amide; unsaturated dicarboxylic acids (for example, acrylic acid, butenoic acid, methacrylic acid, ethylacrylic acid, pentenoic acid, decenoic acids, undecenoic acids, dodecenoic acids, linoleic acid, etc.); esters, acid amides or anhydrides of the foregoing unsaturated carboxylic acids; unsaturated alcohols (for example, alkanols, crotyl alcohol, methyl vinyl carbinol, 4-pentene-1-ol, 1,4-hexadiene-3-ol, 3-butene-1,4-diol, 2,5-dimethyl-3-hexene-2,5-diol, and alcohols of the formula CₙH₂ₙ-5OH, CₙH₂ₙ-7OH and CₙH₂ₙ-9OH, wherein n is a positive integer less than or equal to 30); unsaturated amines resulting from replacing from replacing the —OH group(s) of the above unsaturated alcohols with —NH₂ group(s); functionalized diene polymers and copolymers; and combinations comprising one or more of the foregoing. In an aspect, the compatibilizing agent comprises maleic anhydride, fumaric acid, or a combination thereof.

The second type of polyfunctional compatibilizing agent has both (a) a group represented by the formula (OR) wherein R is hydrogen or an alkyl, aryl, acyl or carbonyl dioxy group and (b) at least two groups each of which can be the same or different selected from carboxylic acid, acid halide, anhydride, acid halide anhydride, ester, orthoester, amide, imido, amino, and various salts thereof. Typical of this group of compatibilizing agents are the aliphatic polycarboxylic acids, acid esters, and acid amides represented by the formula:

(R^{I}O)ₘR′(COOR^{III})ₙ(CONR^{III}R^{IV})ₛ

wherein R′ is a linear or branched chain, saturated aliphatic hydrocarbon having 2 to 20, or, more specifically, 2 to 10, carbon atoms; R^{I} is hydrogen or an alkyl, aryl, acyl, or carbonyl dioxy group having 1 to 10, or, more specifically, 1 to 6, or, even more specifically, 1 to 4 carbon atoms; each R^{II} is independently hydrogen or an alkyl or aryl group having 1 to 20, or, more specifically, 1 to 10 carbon atoms; each R^{III} and R^{IV} are independently hydrogen or an alkyl or aryl group having 1 to 10, or, more specifically, 1 to 6, or, even more specifically, 1 to 4, carbon atoms; m is equal to 1 and (n+s) is greater than or equal to 2, or, more specifically, equal to 2 or 3, and n and s are each greater than or equal to zero and wherein (ORI) is alpha or beta to a carbonyl group and at least two carbonyl groups are separated by 2 to 6 carbon atoms. Obviously, R^{I}, R^{II}, R^{III}, and R^{IV} cannot be aryl when the respective substituent has less than 6 carbon atoms.

Suitable polycarboxylic acids include, for example, citric acid, malic acid, and agaricic acid, including the various commercial forms thereof, such as for example, the anhydrous and hydrated acids; and combinations comprising one or more of the foregoing. In an aspect, the compatibilizing agent comprises citric acid. Illustrative of esters useful herein include, for example, acetyl citrate, monostearyl and/or distearyl citrates, and the like. Suitable amides useful herein include, for example, N,N′-diethyl citric acid amide; N-phenyl citric acid amide; N-dodecyl citric acid amide; N,N′-didodecyl citric acid amide; and N dodecyl malic acid. Derivatives include the salts thereof, including the salts with amines and the alkali and alkaline metal salts. Examples of suitable salts include calcium malate, calcium citrate, potassium malate, and potassium citrate.

The third type of polyfunctional compatibilizing agent has in the molecule both (a) an acid halide group and (b) at least one carboxylic acid, anhydride, ester, epoxy, orthoester, or amide group, preferably a carboxylic acid or anhydride group. Examples of compatibilizing agents within this group include trimellitic anhydride acid chloride, chloroformyl succinic anhydride, chloroformyl succinic acid, chloroformyl glutaric anhydride, chloroformyl glutaric acid, chloroacetyl succinic anhydride, chloroacetylsuccinic acid, trimellitic acid chloride, and chloroacetyl glutaric acid. In an aspect, the compatibilizing agent comprises trimellitic anhydride acid chloride.

In a specific aspect, the compatibilizing agent can comprise maleic acid, maleic anhydride, citric acid, fumaric acid, or a combination thereof. In an aspect, the compatibilizing agent can comprise citric acid.

The compatibilizing agent can be present in the composition in an amount of 0.01 to 10 weight percent, based on the total weight of the composition. Within this range, the compatibilizing agent can be present in an amount of 0.01 to 5 weight percent, or 0.01 to 1.5 weight percent, or 0.1 to 10 weight percent, or 0.1 to 5 weight percent, or 0.2 to 1 weight percent, or 0.4 to 0.9 weight percent, each based on the total weight of the composition.

The composition can optionally further comprise an additive composition, comprising one or more additives selected to achieve a desired property, with the proviso that the additives are also selected so as to not significantly adversely affect a desired property of the composition. The additive composition or individual additives can be mixed at a suitable time during the mixing of the components for forming the composition. The additive composition can include flow modifier, filler (e.g., a particulate polytetrafluoroethylene (PTFE), glass, carbon, mineral, or metal), antioxidant, heat stabilizer, light stabilizer, ultraviolet (UV) light stabilizer, UV absorbing additive, plasticizer, lubricant, release agent (such as a mold release agent), antistatic agent, anti-fog agent, antimicrobial agent, colorant (e.g., a dye or pigment), surface effect additive, radiation stabilizer, flame retardant, anti-drip agent (e.g., a PTFE-encapsulated styrene-acrylonitrile copolymer (TSAN)), or a combination thereof. The additives are used in the amounts generally known to be effective. For example, the total amount of the additive composition (other than any impact modifier, filler, or reinforcing agent) can be 0.001 to 10 weight percent, or 0.1 to 10 weight percent, or 0.01 to 5 weight percent, each based on the total weight of the polymer in the composition. In an aspect the composition can exclude additives not specifically disclosed herein.

In a specific aspect, the thermoplastic composition can comprise 32 to 50 weight percent of the poly(phenylene ether); 34 to 55 weight percent of the polyamide; 3 to 15 weight percent of the impact modifier comprising a polystyrene-poly(ethylene-propylene) diblock copolymer and a polystyrene-poly(ethylene-butylene)-polystyrene triblock copolymer; 0.5 to 5 weight percent of the conductive agent; 1 to 7.5 weight percent of a hydroxy-containing compound comprising bisphenoxyethanol fluorene, a terpene phenolic resin, a novolak resin, or a combination thereof; and 0.1 to 3 weight percent of the compatibilizing agent.

In another specific aspect, the poly(phenylene ether) comprises a poly(2,6-dimethyl-1,4-phenylene ether) having an intrinsic viscosity of 0.33 to 0.46 deciliter per gram, as measured by Ubbelohde viscometer in chloroform at 25° C.; the polyamide comprises polyamide-6,6; the conductive agent comprises carbon nanotubes; and compatibilizing agent comprises maleic acid, maleic anhydride, citric acid, fumaric acid, or a combination thereof, preferably citric acid.

In another specific aspect, the thermoplastic composition can comprise 32 to 50 weight percent of the poly(phenylene ether); 34 to 55 weight percent of the polyamide; 3 to 15 weight percent of the impact modifier comprising a polystyrene-poly(ethylene-propylene) diblock copolymer and a polystyrene-poly(ethylene-butylene)-polystyrene triblock copolymer; 0.5 to 5 weight percent of the conductive agent; 1 to 7.5 weight percent of a hydroxy-containing compound comprising bisphenoxyethanol fluorene, a terpene phenolic resin, a novolak resin, or a combination thereof; and 0.1 to 3 weight percent of the compatibilizing agent; wherein the poly(phenylene ether) comprises a poly(2,6-dimethyl-1,4-phenylene ether) having an intrinsic viscosity of 0.33 to 0.46 deciliter per gram, as measured by Ubbelohde viscometer in chloroform at 25° C.; the polyamide comprises polyamide-6,6; the conductive agent comprises carbon nanotubes; and compatibilizing agent comprises maleic acid, maleic anhydride, citric acid, fumaric acid, or a combination thereof, preferably citric acid.

The relative amount of each component can be adjusted to provide the desired combination of properties. As is understood by one of skill in the art, the amount of each component can be selected within the recited ranges such that they total 100 weight percent.

The composition can optionally exclude or minimize components not specifically described herein. In an aspect, the composition can exclude or minimize (e.g., less than 5 weight percent, or less than 1 weight percent, or less than 0.1 weight percent) thermoplastic polymers other than the poly(phenylene ether), the polyamide, and the impact modifier. In an aspect the composition can exclude or minimize homopolystyrene. In an aspect, the composition can exclude or minimize rubber-modified polystyrene. In an aspect, the composition can exclude or minimize impact modifiers other than the hydrogenated block copolymer.

The composition of the present disclosure can exhibit one or more advantageous properties. For example, a molded sample of the composition can exhibit a notched Izod impact strength of greater than or equal to 7 kilojoules per meter squared (kJ/m₂), or greater than or equal to 10 KJ/m², as determined according to ISO 180. The composition can exhibit a water absorption of less than 1%, or less than 0.9%, or less than 0.8%, or less than 0.75%, or less than 0.7%, or less than 0.6%, or less than 0.5%, or 0.01 to 0.75%, or 0.05 to 0.5%. The composition can exhibit a melt volume flow rate of greater than 10 cubic centimeters per 10 minutes (cm³/10 minutes), or greater than 12 cm³/10 minutes, or greater than 15 cm³/10 minutes, as determined according to ISO 1133. The composition can exhibit a specific volume resistivity of less than 6000 ohm-centimeters (ohm-cm), or less than 5000 ohm-cm, for example, 500 to less than 6000 ohm-cm, or 500 to less than 5000 ohm-cm. The aforementioned properties can be determined, for example, according to the test standards and procedures further described in the working examples below.

The composition can generally be prepared by any method. In an aspect, the composition can be prepared by melt mixing the components of the composition. For example, the composition can be formed by combining the components of the composition. In an aspect, the components of the composition can be dry blended, and the dry blend can be added into an upstream port of an extruder. The dry blend can then be melt mixed. In an aspect, the polyamide and, when present, any filler, can be added to the melt mix using separate downstream feeders. Typical melt mixing temperatures can be 250 to 350° C. Molded articles can be formed from the composition, for example, by injection molding or extrusion. An exemplary method for the manufacture of the composition is further described in the working examples below.

The composition can be useful in various applications, in particular, automotive applications. Thus, another aspect of the present disclosure is an article formed from the composition in any of its above-described variations. Such articles include components employed in the interiors of vehicles including automobiles, aircraft, ships, trains, and subway cars. A specific article is an automotive component, for example an automotive body panel or service flap.

The composition of the present disclosure therefore provides a significant advantage with regard to certain properties, for example melt flow, water uptake, and impact strength. The composition exhibiting this desirable balance of properties can be particularly useful for forming articles for various applications, as well as for use in reinforced thermoplastic composite materials. Therefore, a significant advantage is provided by the present disclosure.

This disclosure is further illustrated by the following examples, which are non-limiting.

### EXAMPLES

Materials used for the following examples are described in Table 1.

TABLE 1

| Component | Description | Supplier |
|---|---|---|
| PPE | Poly(2,6-dimethyl-1,4-phenylene ether), CAS Reg. No. 24938-67-8, having an | SABIC |
| | intrinsic viscosity of 0.4 deciliter per gram as measured in chloroform at 25° C.; | |
| | obtained as PPO 640 | |
| PA66 | Polyamide-6,6, CAS Reg. No. 32131-17-2, having a melting point of 265° C.; | Ascend |
| | obtained as VYDYNE 21ZLV | |
| PA610 | Polyamide-6,10 CAS 9011-52-3, obtained as RADIPOL DC40 | Radici |
| | | Chimica s.p.a. |
| SEBS | Polystyrene-poly(ethylene-butylene)-polystyrene triblock copolymer, CAS Reg. | Kraton |
| | No. 66070-58-4, obtained as KRATON G1651 | Performance |
| | | Polymers, Inc. |
| SEP | Polystyrene-poly(ethylene-propylene) diblock copolymer, CAS Reg. No. 68648- | Kuraray |
| | 89-5, having a polystyrene content of 36 weight percent, obtained as SEPTON | |
| | 1001 | |
| CA | Citric acid, CAS Reg. No. 77-92-9 | International |
| | | Chemical, Inc |
| CuI | Copper Iodide | Godo Shigen |
| KI | Potassium Iodide | Wako |
| H₂O | Demineralized water | Heisei riken |
| AO | Octadecyl 3,5-di-tert-butyl-4-hydroxyhydrocinnamate, CAS Reg. No. 2082-79-3; | BASF |
| | obtained as IRGANOX 1076 | |
| CNT- | Carbon nanotube masterbatch including 17 weight percent multiwall carbon | Nanocyl |
| PA66-1 | nanotubes and 83 weight percent polyamide-6,6, obtained as PLASTICYL | |
| | PA1701P | |
| CNT- | Carbon nanotube masterbatch including 10 weight percent multiwall carbon | Nanocyl |
| PA66-2 | nanotubes and 90 weight percent polyamide-6,6, obtained as PLASTICYL | |
| | PA1001P | |
| BPEF | Bisphenoxyethanol fluorene, obtained as OGSOL MF-11 | Osaka Gas |
| | | Chemical |
| PhOH-1 | Uncured phenol novolak resin having a softening point 125° C. and a solution | Sumitomo |
| | viscosity 250 CSt, and having 2% unreacted phenol, obtained as | Bakelite |
| | SUMILITERESIN PR-50731 | |
| PhOH-2 | Novolak resin having a free monomer component of 0.3% by weight and a dimer | Sumitomo |
| | component of 17% by weight, obtained as SUMILITERESIN PR-53195 | Bakelite |
| PhOH-3 | Phenolic novolak resin having a softening point 78-82° C., PHENOLITE TD-2131 | DIC |
| PhOH-4 | Phenolic novolak resin having a softening point 117-123° C., PHENOLITE TD- | DIC |
| | 2090 | |
| PhOH-5 | Bisphenol A novolak resin having a softening point 125-140° C., PHENOLITE | DIC |
| | KH-6021 | |
| PhOH-6 | Terpene phenolic resin having a softening point of 145° C. and a hydroxyl value | Yasuhara |
| | of 100 mg KOH/g, obtained as S145 | Chemical |

Compositions were compounded using a Toshiba TEM50A compounder. All components were added at the feedthroat except the pre-blended PA-66/CNT masterbatch, which was added downstream using a side feeder. The compounding was conducted at a barrel temperature of 300° C. under a screw rotation of 330 RPM with a throughput of 80 kg/h. Strands having a diameter of 3 millimeters were extruded through the due and cooled in a water bath prior to pelletizing. Pellets were dried at 120° C. for 4 hours prior to injection molding. Test specimens were prepared using a 100-ton injection molding machine operating at a melt temperature of 280° C. and a mold temperature of 80° C. Properties of the molded parts were tested according to the following standards summarized in Table 2.

TABLE 2

| Property | Test Standard |
|---|---|
| Tensile testing, 50 mm/min | ISO 527 |
| Flexural testing, 2.0 mm/min | ISO 178 |
| Izod Impact - Notched (NII) | ISO 180 |
| Melt volume flow rate (MVR), 280° C./5 kg | ISO 1133 |
| Melt Viscosity (MV), 282° C., 1500 s⁻¹ | ISO 11443 |
| Vicat, B/120 | ISO 306 |
| Density | ISO 1183 |
| Water absorption (23° C./48 hrs water immersion) | ISO 62 |

Water absorption was calculated according to the formula: Increase in weight (percent, %)=((wet weight−dry weight)/dry weight)×100.

Specific volume resistivity (SVR) values, expressed in units of ohm-centimeters, were determined at 23° C. as follows. A tensile bar was molded according to ISO 3167-2002. A sharp, shallow cut was made near each end of the narrow central portion of the bar. The bar was fractured in a brittle fashion at each cut to separate the narrow central portion having fractured ends with cross-sectional dimensions of 10 millimeters by 4 millimeters. In order to obtain fracturing in a brittle fashion, the tensile bar was cooled, for example, in dry ice, in a freezer at −40° C., or in liquid nitrogen. The length of the bar between the fractured ends was measured. The fractured ends of the sample were painted with conductive silver paint, and the paint was allowed to dry. Using a multi-meter, electrodes were attached to each of the painted surfaces, and the resistance was measured at an applied voltage of 500 millivolts to 1000 millivolts. Values of specific volume resistivity were obtained by multiplying the measured resistance by the fracture area of one side of the bar and dividing by the length of the bar

r=R×A/L

where r is the specific volume resistivity in ohm-centimeters, R is the measured resistance in ohms, A is the fractured area in square centimeters, and L is the sample length in centimeters. The procedure was repeated for a total of five samples, and the results for the five samples were averaged to provide the reported specific volume resistivity value.

Compositions and properties are summarized in Tables 3A, 3B, 3C and 3D. The amount of each component is provided in weight percent based on the total weight of the composition.

TABLE 3A

| | Unit | CE1 | CE2 | CE3 | CE4 | E1 | E2 | E3 |
|---|---|---|---|---|---|---|---|---|
| Comp. | | | | | | | | |
| PPE | wt % | 38.54 | 43.54 | 48.54 | 52.94 | 40.54 | 45.54 | 49.94 |
| PA66 | wt % | 44.4 | 39.4 | 34.4 | 30 | 39.4 | 34.4 | 30 |
| SEBS | wt % | 7 | 7 | 7 | 7 | 7 | 7 | 7 |
| SEP | wt % | 3.5 | 3.5 | 3.5 | 3.5 | 3.5 | 3.5 | 3.5 |
| CA | wt % | 0.65 | 0.65 | 0.65 | 0.65 | 0.65 | 0.65 | 0.65 |
| CuI | wt % | 0.01 | 0.01 | 0.01 | 0.01 | 0.01 | 0.01 | 0.01 |
| KI | wt % | 0.05 | 0.05 | 0.05 | 0.05 | 0.05 | 0.05 | 0.05 |
| H2O | wt % | 0.05 | 0.05 | 0.05 | 0.05 | 0.05 | 0.05 | 0.05 |
| AO | wt % | 0.3 | 0.3 | 0.3 | 0.3 | 0.3 | 0.3 | 0.3 |
| CNT- | wt % | 5.5 | 5.5 | 5.5 | 5.5 | 5.5 | 5.5 | 5.5 |
| PA66-1 | | | | | | | | |
| BPEF | wt % | | | | | 3 | 3 | 3 |
| PhOH-1 | wt % | | | | | | | |
| Properties | | | | | | | | |
| SVR | ohm- | 81876 | 8151 | 15736 | 155523 | 3871 | 1260 | 2145 |
| | cm | | | | | | | |
| NII | kJ/m² | 19 | 18 | 19 | 7 | 15 | 14 | 7 |
| Tens. | Mpa | 59 | 60 | 59 | 60 | 59 | 60 | 61 |
| Strength | | | | | | | | |
| Tens. | % | 84 | 103 | 92 | 14 | 91 | 60 | 10 |
| Elong. | | | | | | | | |
| Flex. | Mpa | 84 | 86 | 85 | 86 | 89 | 88 | 86 |
| Strength | | | | | | | | |
| Flex. | Mpa | 2187 | 2163 | 2137 | 2124 | 2220 | 2170 | 2143 |
| Mod. | | | | | | | | |
| VICAT | ° C. | 199.1 | 200.1 | 202.0 | 202.0 | 198.6 | 195.8 | 196.5 |
| MVR | cc/10 | 18.5 | 12.8 | 8.8 | 6.3 | 27.4 | 18.5 | 11.8 |
| | min | | | | | | | |
| MV | Pa · s | 260 | 296 | | | | | |
| Water | % | 0.88 | 0.82 | 0.78 | 0.75 | 0.77 | 0.74 | 0.71 |
| Abs. | | | | | | | | |

| | Unit | E4 | E5 | E6 | E7 | E8 | E9 | E10 |
|---|---|---|---|---|---|---|---|---|
| Comp. | | | | | | | | |
| PPE | wt % | 38.54 | 43.54 | 47.94 | 38.54 | 43.54 | 33.54 | 38.54 |
| PA66 | wt % | 39.4 | 34.4 | 30 | 39.4 | 34.4 | 39.4 | 34.4 |
| SEBS | wt % | 7 | 7 | 7 | 7 | 7 | 7 | 7 |
| SEP | wt % | 3.5 | 3.5 | 3.5 | 3.5 | 3.5 | 3.5 | 3.5 |
| CA | wt % | 0.65 | 0.65 | 0.65 | 0.65 | 0.65 | 0.65 | 0.65 |
| CuI | wt % | 0.01 | 0.01 | 0.01 | 0.01 | 0.01 | 0.01 | 0.01 |
| KI | wt % | 0.05 | 0.05 | 0.05 | 0.05 | 0.05 | 0.05 | 0.05 |
| H2O | wt % | 0.05 | 0.05 | 0.05 | 0.05 | 0.05 | 0.05 | 0.05 |
| AO | wt % | 0.3 | 0.3 | 0.3 | 0.3 | 0.3 | 0.3 | 0.3 |
| CNT- | wt % | 5.5 | 5.5 | 5.5 | 5.5 | 5.5 | 5.5 | 5.5 |
| PA66-1 | | | | | | | | |
| BPEF | wt % | 5 | 5 | 5 | | | | |
| PhOH-1 | wt % | | | | 5 | 5 | 10 | 10 |
| Properties | | | | | | | | |
| SVR | ohm- | 5952 | 1118 | 865 | 3281 | 1253 | 3156 | 1344 |
| | cm | | | | | | | |
| NII | kJ/m² | 12 | 13 | 6 | 14 | 13 | 3 | 4 |
| Tens. | Mpa | 60 | 61 | 62 | 61 | 60 | 60 | 62 |
| Strength | | | | | | | | |
| Tens. | % | 80 | 66 | 12 | 59 | 53 | 5 | 9 |
| Elong. | | | | | | | | |
| Flex. | Mpa | 89 | 88 | 88 | 89 | 90 | 93 | 92 |
| Strength | | | | | | | | |
| Flex. | Mpa | 2288 | 2262 | 2252 | 2346 | 2360 | 2449 | 2434 |
| Mod. | | | | | | | | |
| VICAT | ° C. | 195.7 | 194.5 | 191.5 | 194.2 | 198.2 | 185.8 | 187.8 |
| MVR | cc/10 | 37.2 | 24.8 | 17.8 | 22.5 | 14.7 | 33.3 | 21.6 |
| | min | | | | | | | |
| MV | Pa · s | | | | 220 | 244 | 172 | 205 |
| Water | % | 0.75 | 0.73 | 0.70 | 0.60 | 0.57 | 0.51 | 0.48 |
| Abs. | | | | | | | | |

TABLE 3B

| | Unit | E11 | E12 | E13 | E14 | E15 | E16 | E17 | E18 | E19 | E20 |
|---|---|---|---|---|---|---|---|---|---|---|---|
| Comp. | | | | | | | | | | | |
| PPE | wt % | 45.94 | 43.94 | 41.94 | 45.94 | 43.94 | 41.94 | 49.94 | 39.94 | 39.94 | 39.94 |
| PA66 | wt % | 34 | 34 | 34 | 34 | 34 | 34 | 34 | 38 | 38 | 38 |
| SEBS | wt % | 7 | 7 | 7 | 7 | 7 | 7 | 7 | 7 | 7 | 7 |
| SEP | wt % | 3.5 | 3.5 | 3.5 | 3.5 | 3.5 | 3.5 | 3.5 | 3.5 | 3.5 | 3.5 |
| CA | wt % | 0.65 | 0.65 | 0.65 | 0.65 | 0.65 | 0.65 | 0.65 | 0.65 | 0.65 | 0.65 |
| CuI | wt % | 0.01 | 0.01 | 0.01 | 0.01 | 0.01 | 0.01 | 0.01 | 0.01 | 0.01 | 0.01 |
| KI | wt % | 0.05 | 0.05 | 0.05 | 0.05 | 0.05 | 0.05 | 0.05 | 0.05 | 0.05 | 0.05 |
| H2O | wt % | 0.05 | 0.05 | 0.05 | 0.05 | 0.05 | 0.05 | 0.05 | 0.05 | 0.05 | 0.05 |
| AO | wt % | 0.3 | 0.3 | 0.3 | 0.3 | 0.3 | 0.3 | 0.3 | 0.3 | 0.3 | 0.3 |
| CNT- | wt % | 5.5 | 5.5 | 5.5 | 5.5 | 5.5 | 5.5 | 5.5 | 5.5 | 5.5 | 5.5 |
| PA66-1 | | | | | | | | | | | |
| PhOH-1 | wt % | 3 | 5 | 7 | | | | | | | |
| PhOH-2 | wt % | | | | 3 | 5 | 7 | 9 | | | |
| PhOH-3 | wt % | | | | | | | | 5 | | |
| PhOH-4 | wt % | | | | | | | | | 5 | |
| PhOH-5 | wt % | | | | | | | | | | 5 |
| Properties | | | | | | | | | | | |
| SVR | ohm-cm | 828 | 943 | 1223 | 816 | 822 | 2169 | 3600 | 1044 | 1064 | 1930 |
| NII | kJ/m² | 20 | 19 | 15 | 17 | 13 | 7 | 4 | 12 | 17 | 11 |
| Tens. | Mpa | 59 | 61 | 61 | 59 | 59 | 60 | 60 | 60 | 61 | 61 |
| Strength | | | | | | | | | | | |
| Tens. | % | 85 | 75 | 57 | 106 | 75 | 53 | 12 | 41 | 57 | 27 |
| Elong. | | | | | | | | | | | |
| VICAT | ° C. | 199 | 198 | 194 | 199 | 197 | 195 | 188 | 198 | 200 | 197 |
| MVR | cc/10 min | | | | | | | | 32.4 | 18.9 | 43.1 |
| MV | Pa · s | 290 | 265 | 232 | 295 | 225 | 209 | 167 | 183 | 227 | 169 |
| Water Abs. | % | 0.58 | 0.52 | 0.46 | 0.57 | 0.50 | 0.46 | 0.42 | 0.48 | 0.49 | 0.48 |

TABLE 3C

| | Unit | CE5 | CE6 | E21 | E22 | E23 | E24 | E25 | E26 | E27 | CE7 |
|---|---|---|---|---|---|---|---|---|---|---|---|
| Comp. | | | | | | | | | | | |
| PPE | wt % | 38.39 | 43.68 | 37.04 | 33.49 | 38.79 | 39.94 | 38.79 | 39.89 | 35.54 | 52.94 |
| PA66 | wt % | 44.4 | 39 | 44.4 | 44.4 | 39 | 34.15 | 35.15 | 40.55 | 44.4 | 30 |
| SEBS | wt % | 7 | 7 | 7 | 7 | 7 | 7 | 7 | 7 | 7 | 7 |
| SEP | wt % | 3.5 | 3.5 | 3.5 | 3.5 | 3.5 | 3.5 | 3.5 | | 3.5 | 3.5 |
| CA | wt % | 0.8 | 0.91 | 0.65 | 0.7 | 0.8 | 0.65 | 0.8 | 0.8 | 0.65 | 0.65 |
| CuI | wt % | 0.01 | 0.01 | 0.01 | 0.01 | 0.01 | 0.01 | 0.01 | 0.01 | 0.01 | 0.01 |
| KI | wt % | 0.05 | 0.05 | 0.05 | 0.05 | 0.05 | 0.05 | 0.05 | 0.05 | 0.05 | 0.05 |
| H2O | wt % | 0.05 | 0.05 | 0.05 | 0.05 | 0.05 | 0.05 | 0.05 | 0.05 | 0.05 | 0.05 |
| AO | wt % | 0.3 | 0.3 | 0.3 | 0.3 | 0.3 | 0.3 | 0.3 | 0.3 | 0.3 | 0.3 |
| CNT- | wt % | 5.5 | 5.5 | 5.5 | 5.5 | 5.5 | | | | 5.5 | 5.5 |
| PA66-1 | | | | | | | | | | | |
| CNT- | | | | | | | 9.35 | 9.35 | 9.35 | | |
| PA66-2 | | | | | | | | | | | |
| PhOH-2 | wt % | | | 1.5 | 5 | 5 | 5 | 5 | 2 | | |
| PhOH-6 | wt % | | | | | | | | | 3 | |
| Properties | | | | | | | | | | | |
| SVR | ohm-cm | 12284 | 40581 | 4485 | 2291 | 959 | 609 | 856 | 1502 | 3894 | 155523 |
| NII | kJ/m² | 27 | 27 | 24 | 22 | 21 | 14 | 13 | 14 | 25 | 7 |
| Tens. | Mpa | 58 | 59 | 60 | 61 | 61 | 61 | 61 | 67 | 59 | 60 |
| Strength | | | | | | | | | | | |
| Tens. | % | 77 | 63 | 80 | 53 | 41 | 48 | 49 | 52 | 60 | 14 |
| Elong. | | | | | | | | | | | |
| VICAT | ° C. | 201 | 202 | 200 | 198 | 201 | 199 | 199 | 207 | 194 | 202 |
| MVR | cc/10 min | 13.6 | 8.5 | 23.4 | 26.8 | 17.7 | 18.8 | 24.4 | 19.8 | 25.0 | 6.3 |
| Water | % | 0.82 | 0.74 | 0.75 | 0.64 | 0.63 | 0.49 | 0.50 | 0.74 | 0.79 | 0.75 |
| Abs. | | | | | | | | | | | |

TABLE 3D

| Comp. | Unit | CE8 | E27 | E28 | E29 |
|---|---|---|---|---|---|
| PPE | wt % | 38.54 | 38.54 | 38.54 | 38.54 |
| PA610 | wt % | 43.9 | 41.4 | 38.9 | 36.4 |
| SEBS | wt % | 7 | 7 | 7 | 7 |
| SEP | wt % | 3.5 | 3.5 | 3.5 | 3.5 |
| CA | wt % | 0.65 | 0.65 | 0.65 | 0.65 |
| CuI | wt % | 0.01 | 0.01 | 0.01 | 0.01 |
| KI | wt % | 0.1 | 0.1 | 0.1 | 0.1 |
| AO | wt % | 0.3 | 0.3 | 0.3 | 0.3 |
| CNT- | wt % | 6 | 6 | 6 | 6 |
| PA66-1 | | | | | |
| PhOH-2 | wt % | | 2.5 | 5 | 7.5 |
| Total PA | wt % | 48.88 | 46.38 | 43.88 | 41.38 |
| content | | | | | |
| Properties | | | | | |
| NII | kJ/m² | 21 | 17 | 18 | 10 |
| Tens. | Mpa | 57 | 58 | 59 | 58 |
| Strength | | | | | |
| Tens. | % | 20 | 16 | 11 | 13 |
| Elong. | | | | | |
| Flex. | Mpa | 81 | 84 | 87 | 86 |
| Strength | | | | | |
| Flex. | Mpa | 2048 | 2108 | 2190 | 2222 |
| Mod. | | | | | |
| VICAT | ° C. | 181.5 | 179.9 | 177.3 | 170.6 |
| MVR | cc/10 | 18.1 | 17.2 | 26.4 | 37.3 |
| | min | | | | |
| Water | % | 0.43 | 0.37 | 0.32 | 0.26 |
| Abs. | | | | | |

As shown in Table 3, the water uptake can be reduced by reducing the amounts of polyamide (e.g., PA66) in the composition, as indicated by Comparative Examples 1-4. However, MVR is undesirably affected. The compositions according to Examples 1-10 show that by adding BPEF or a particular phenolic compound, water uptake reduction can be achieved, the SVR can be improved, and the MVR is maintained or improved compared to comparative example 1.

Also as shown in Table 3, a phenolic resin having a lower level of phenol residue (PhOH-2 compared to PhOH-1) was shown to provide water uptake reduction with an improvement in conductivity. Example 21 and 26 contains the same amount of PA as Comparative Example 1 and shows that by adding a small amount of PhOH-2 or PhOH-6, the same level of water absorption relative to the composition having a lower amount of PA can be obtained, but with improved mechanical properties and conductivity.

A significant improvement is therefore provided by the present disclosure.

This disclosure further encompasses the following aspects.

Aspect 1: A thermoplastic composition, comprising: 30 to 60 weight percent of a poly(phenylene ether); 30 to 60 weight percent of a polyamide; 1 to 20 weight percent of an impact modifier; 0.1 to 10 weight percent of a conductive agent; 1 to 10 weight percent of a hydroxy-containing compound comprising bisphenoxyethanol fluorene, a terpene phenolic resin, a novolak resin, or a combination thereof; and 0.01 to 10 weight percent of a compatibilizing agent; wherein weight percent is based on the total weight of the thermoplastic composition.

Aspect 2: The thermoplastic composition of aspect 1, wherein the poly(phenylene ether) comprises a poly(2,6-dimethyl-1,4-phenylene ether), preferably having an intrinsic viscosity of 0.33 to 0.46 deciliter per gram, as measured by Ubbelohde viscometer in chloroform at 25° C.

Aspect 3: The thermoplastic composition of aspect 1 or 2, wherein the polyamide comprises a polyamide-6, a polyamide-6,6, a polyamide-6,10, a polyamide-4,10, a polyamide-5,10, polyamide 10,10, polyamide 9T, polyamide 6T, polyamide 10T, polyamide 6I, polyamide MXD6, or a combination thereof, preferably a polyamide-6,6, optionally wherein the polyamide is a biopolyamide, a recycled polyamide, or an upcycled polyamide.

Aspect 4: The thermoplastic composition of any of aspects 1 to 3, wherein the impact modifier comprises a hydrogenated block copolymer, preferably wherein the hydrogenated block copolymer comprises a polystyrene-poly(ethylene-propylene) diblock copolymer, a polystyrene-poly(ethylene-butylene)-polystyrene triblock copolymer, or a combination thereof; more preferably wherein the hydrogenated block copolymer has a polystyrene content of 28 to 37 weight percent; even more preferably wherein the hydrogenated block copolymer comprises the polystyrene-poly(ethylene-propylene) diblock copolymer and the polystyrene-poly(ethylene-butylene)-polystyrene triblock copolymer.

Aspect 5: The thermoplastic composition of any of aspects 1 to 4, wherein the conductive agent is conductive carbon black, Ketjen black, carbon nanotubes, carbon fibers, graphite, metal fibers, metal particles, particles of conductive polymers, metal-coated carbon fibers, or a combination thereof, or conductive carbon black, carbon fiber, carbon nanotubes, or a combination thereof.

Aspect 6: The conductive thermoplastic composition of any of claims 1 to 5, wherein the conductive agent comprises a conductive carbon black having a BET specific surface area of at least 50 m²/g, an OAN value of at least 140 ml/100 g when tested in accordance with ASTM D 2414 and/or D 3493, or both.

Aspect 7: The thermoplastic composition of any of aspects 1 to 6, wherein the conductive agent comprises carbon nanotubes, preferably multiwall carbon nanotubes having an average diameter of 2 to 20 nanometers.

Aspect 8: The thermoplastic composition of any of aspects 1 to 7, wherein the hydroxy-containing compound comprises the bisphenoxyethanol fluorene.

Aspect 9: The thermoplastic composition of any of aspects 1 to 8, wherein the hydroxy-containing compound comprises the terpene phenolic resin, preferably wherein the terpene phenolic resin has a hydroxyl value of 50 to 150 mg KOH/g.

Aspect 10: The thermoplastic composition of any of aspects 1 to 7, wherein the hydroxy-containing compound comprises the novolak resin.

Aspect 11: The thermoplastic composition of any of aspects 1 to 10, wherein the compatibilizing agent comprises maleic acid, maleic anhydride, citric acid, fumaric acid, or a combination thereof, preferably citric acid.

Aspect 12: The thermoplastic composition of any of aspects 1 to 11, wherein the thermoplastic composition is the product of melt-blending the components of the composition.

Aspect 13: The composition of any of aspects 1 to 12, comprising: 32 to 50 weight percent of the poly(phenylene ether); 34 to 55 weight percent of the polyamide; 3 to 15 weight percent of the impact modifier comprising a polystyrene-poly(ethylene-propylene) diblock copolymer and a polystyrene-poly(ethylene-butylene)-polystyrene triblock copolymer; 0.5 to 5 weight percent of the conductive agent; 1 to 7.5 weight percent of a hydroxy-containing compound comprising bisphenoxyethanol fluorene, a terpene phenolic resin, a novolak resin, or a combination thereof; and 0.1 to 3 weight percent of the compatibilizing agent.

Aspect 14: The composition of aspect 13, wherein the poly(phenylene ether) comprises a poly(2,6-dimethyl-1,4-phenylene ether) having an intrinsic viscosity of 0.33 to 0.46 deciliter per gram, as measured by Ubbelohde viscometer in chloroform at 25° C.; the polyamide comprises polyamide-6,6; the conductive agent comprises carbon nanotubes; and compatibilizing agent comprises maleic acid, maleic anhydride, citric acid, fumaric acid, or a combination thereof, preferably citric acid.

Aspect 15: An article comprising the composition of any of aspects 1 to 14, preferably wherein the article is an exterior painted automotive component, an automotive body panel or service flap.

Aspect 16: A method for the manufacture of the composition of any of aspects 1 to 14, the method comprising melt-blending the components of the composition.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

It will be understood that the combined weight of all components of the composition totals 100 weight percent.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. The term “alkyl” means a branched or straight chain, saturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo atoms (e.g., bromo and fluoro), or only chloro atoms can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl), a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A conductive thermoplastic composition, comprising:
30 to 60 weight percent of a poly(phenylene ether);
30 to 60 weight percent of a polyamide;
1 to 20 weight percent of an impact modifier;
0.1 to 10 weight percent of a conductive agent;
1 to 10 weight percent of a hydroxy-containing compound comprising bisphenoxyethanol fluorene, a terpene phenolic resin, a novolak resin, or a combination thereof; and
0.01 to 10 weight percent of a compatibilizing agent;
wherein weight percent is based on the total weight of the thermoplastic composition.

2. The conductive thermoplastic composition of claim 1, wherein the poly(phenylene ether) comprises a poly(2,6-dimethyl-1,4-phenylene ether).

3. The conductive thermoplastic composition of claim 1, wherein the polyamide comprises a polyamide-6, a polyamide-6,6, a polyamide-6,10, a polyamide-4,10, a polyamide-5,10, polyamide 10,10, polyamide 9T, polyamide 6T, polyamide 10T, polyamide 6I, polyamide MXD6, or a combination thereof, optionally wherein the polyamide is a biopolyamide, a recycled polyamide, or an upcycled polyamide.

4. The conductive thermoplastic composition of claim 1, wherein the impact modifier comprises a hydrogenated block copolymer.

5. The conductive thermoplastic composition of claim 1, wherein the conductive agent is
conductive carbon black, Ketjen black, carbon nanotubes, carbon fibers, graphite, metal fibers, metal particles, particles of conductive polymers, metal-coated carbon fibers, or a combination thereof, or
conductive carbon black, carbon fiber, carbon nanotubes, or a combination thereof.

6. The conductive thermoplastic composition of claim 1, wherein the conductive agent comprises a conductive carbon black having a BET specific surface area of at least 50 m²/g, an OAN value of at least 140 ml/100 g when tested in accordance with ASTM D 2414 and/or D 3493, or both.

7. The conductive thermoplastic composition of claim 1, wherein the conductive agent comprises carbon nanotubes.

8. The conductive thermoplastic composition of claim 1, wherein the hydroxy-containing compound comprises the bisphenoxyethanol fluorene.

9. The conductive thermoplastic composition of claim 1, wherein the hydroxy-containing compound comprises the terpene phenolic resin or the novolak resin.

10. The conductive thermoplastic composition of claim 1, wherein the compatibilizing agent comprises maleic acid, maleic anhydride, citric acid, fumaric acid, or a combination thereof.

11. The conductive thermoplastic composition of claim 1, wherein the thermoplastic composition is the product of melt-blending the components of the composition.

12. The conductive thermoplastic composition of claim 1, comprising:
32 to 50 weight percent of the poly(phenylene ether);
34 to 55 weight percent of the polyamide;
3 to 15 weight percent of the impact modifier comprising a polystyrene-poly(ethylene-propylene) diblock copolymer and a polystyrene-poly(ethylene-butylene)-polystyrene triblock copolymer;
0.5 to 5 weight percent of the conductive agent;
1 to 7.5 weight percent of a hydroxy-containing compound comprising bisphenoxyethanol fluorene, a terpene phenolic resin, a novolak resin, or a combination thereof; and
0.1 to 3 weight percent of the compatibilizing agent.

13. The conductive thermoplastic composition of claim 12, wherein
the poly(phenylene ether) comprises a poly(2,6-dimethyl-1,4-phenylene ether) having an intrinsic viscosity of 0.33 to 0.46 deciliter per gram, as measured by Ubbelohde viscometer in chloroform at 25° C.;
the polyamide comprises polyamide-6,6;
the conductive agent comprises carbon nanotubes; and
the compatibilizing agent comprises maleic acid, maleic anhydride, citric acid, fumaric acid, or a combination thereof.

14. An article comprising the conductive thermoplastic composition of claim 1.

15. A method for the manufacture of the conductive thermoplastic composition of claim 1, the method comprising melt-blending the components of the composition.

16. The conductive thermoplastic composition of claim 1, wherein the poly(phenylene ether) comprises a poly(2,6-dimethyl-1,4-phenylene ether) having an intrinsic viscosity of 0.33 to 0.46 deciliter per gram, as measured by Ubbelohde viscometer in chloroform at 25° C.

17. The conductive thermoplastic composition of claim 1, wherein the impact modifier comprises a hydrogenated block copolymer,
wherein the hydrogenated block copolymer comprises a polystyrene-poly(ethylene-propylene) diblock copolymer, a polystyrene-poly(ethylene-butylene)-polystyrene triblock copolymer, or a combination thereof; or
wherein the hydrogenated block copolymer has a polystyrene content of 28 to 37 weight percent; or
wherein the hydrogenated block copolymer comprises the polystyrene-poly(ethylene-propylene) diblock copolymer and the polystyrene-poly(ethylene-butylene)-polystyrene triblock copolymer.

18. The conductive thermoplastic composition of claim 1, wherein the conductive agent comprises multiwall carbon nanotubes having an average diameter of 2 to 20 nanometers.

19. The conductive thermoplastic composition of claim 1, wherein the hydroxy-containing compound comprises the terpene phenolic resin, wherein the terpene phenolic resin has a hydroxyl value of 50 to 150 mg KOH/g.

20. An article comprising the conductive thermoplastic composition of claim 1, wherein the article is an exterior painted automotive component, an automotive body panel or service flap.
